(19) United States
(12) Patent Application Publication
(10) Pub. No.: US 2013/0105046 A1
(43) Pub. Date: May 2, 2013

(54) SYSTEM AND METHOD FOR GENERATING A WELDED ASSEMBLY

(71) Applicants: Blair E. Carlson, Ann Arbor, MI (US); Mark T. Hall, Troy, MI (US)

(72) Inventors: Blair E. Carlson, Ann Arbor, MI (US); Mark T. Hall, Troy, MI (US)

(73) Assignee: GM GLOBAL TECHNOLOGY OPERATIONS LLC, Detroit, MI (US)

(21) Appl. No.: 13/282,538

(22) Filed: Oct. 27, 2011

(51) Int. Cl. C21D 8/00; B23K 11/30; B23K 31/02; C21D 6/00; B23K 1/20

(52) U.S. Cl. 148/526; 148/529; 228/18; 228/212; 228/176; 219/119

(57) ABSTRACT

A method of generating a welded assembly includes providing a work-hardened steel component. The method also includes annealing a region on the work-hardened steel component to impart a local temper to the region such that formability of the region is increased. The method additionally includes forming a projection on the annealed region. Furthermore, the method includes clamping a panel against the projection and joining the panel and the work-hardened steel component at the projection via a welding apparatus to generate the welded assembly. A system for generating a welded assembly employing the disclosed method and a method of generating a reinforced assembly are also disclosed.

### TECHNICAL FIELD

The present invention relates to a system and a method for generating a welded assembly.

### BACKGROUND

Welding is a fabrication or process that joins materials, usually metals or thermoplastics, by causing coalescence. This is often done by melting the substrates of the work-piece and adding a filler material to form a pool of molten material, a.k.a., the weld pool, at the substrate interface. After the weld pool at the substrate interface cools, a high strength joint is produced.

Depending on the type and quality of the materials sought to be joined, the same welding process may expend/consume vastly different amounts of energy to generate a robust weld. In particular, welding of components formed from work-hardened materials, such as ultra-high-strength or boron steel, typically consumes a significant amount of energy. Accordingly, the welding of components from a high-strength steel may require larger, heavier, more powerful, and thus more expensive welding equipment. Such increased consumption of welding energy coupled with the higher cost and size of the welding equipment tends to increase the effective cost of the finished assembly.

### SUMMARY

A method of generating a welded assembly includes providing a work-hardened steel component. The method also includes annealing a region on the work-hardened steel component to impart a local temper to the region such that formability of the region is increased. The method additionally includes forming a projection or a dimple on the annealed region. Furthermore, the method includes clamping a panel against the projection and joining the panel and the work-hardened steel component at the projection via a welding apparatus to generate the welded assembly.

The work-hardened steel component may be formed from a high-strength low-alloy steel and the panel may be formed from mild-steel.

The work-hardened steel component may be a press-hardened structural reinforcement for the panel.

According to the method, the joining of the panel and the work-hardened steel component may be accomplished via electric resistance welding. Additionally, the annealing of the region on the work-hardened steel component may be accomplished via a heating element. Furthermore, the heating element may include an induction coil.

The welding apparatus may include a pair of electrodes. In such a case, the clamping of the panel against the projection may be accomplished via the pair of electrodes.

A system for welding a work-hardened steel component employing the disclosed method and a method of generating a reinforced assembly are also provided.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic illustration of a system for generating a welded assembly, the system being depicted during annealing of specific regions on the press-hardened steel (PHS) component;

FIG. 2 is a schematic illustration of the system shown in FIG. 1, the system being depicted during forming of projections on the PHS component;

FIG. 3 is a schematic illustration of the system shown in FIG. 1, the system being depicted during welding of a mild-steel panel to the projections of the PHS component;

FIG. 4 is a schematic illustration of the finished welded assembly; and

FIG. 5 is a flow chart illustrating a method of generating the welded assembly shown in FIG. 4.

### DETAILED DESCRIPTION

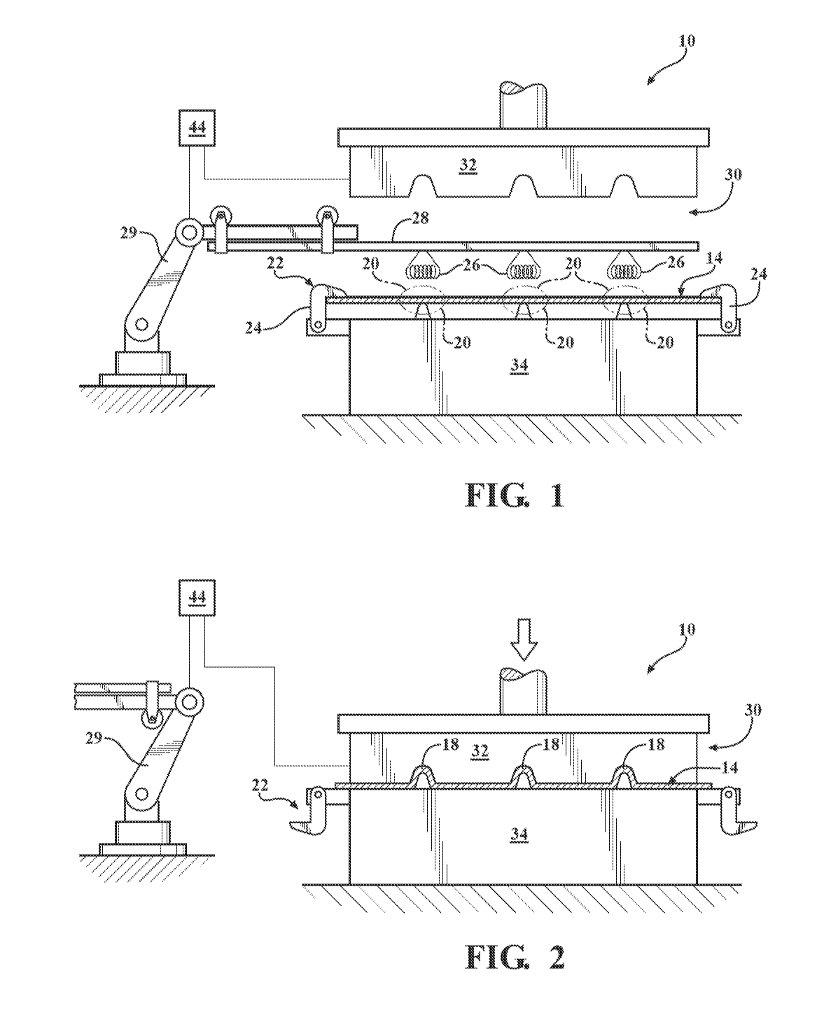

Referring to the drawings in which like elements are identified with identical numerals throughout, FIGS. 1-3 illustrate a system 10 for generating a welded assembly 12 from a component 14 and a panel 16. The completed welded assembly 12 is shown in FIG. 4. As used in the assembly 12, the component 14 is formed from work- or press-hardened steel (PHS), while the panel 16 is formed from low-carbon or mild-steel. The component 14 may be specifically used as a structural reinforcement for the panel 16. As shown, the PHS component 14 includes formed projections 18, and the assembly 12 is generated when the mild-steel panel 16 is welded to the component 14 at the projections.

PHS or boron steel, as it is sometimes referred to, is a high-strength type steel that is typically delivered in sheets of various sizes for forming, quenching, and additional processing. As delivered in its pre-formed state, PHS typically has a yield strength of approximately 350 MPa. However, after forming and quenching the yield strength of PHS typically increases into the 1400-1500 MPa range accompanied by a commensurate decrease in ductility. Frequently, it is desired to join components formed from PHS with components formed from a lower yield strength and/or thinner gauge material, such as the mild-steel panel 16 (which has a yield strength of approximately 250 MPa). Fusion welding is typically chosen for joining formed and quenched PHS components with lower strength and/or thinner gauge material components in order to obtain sufficient weld penetration and generate a robust assembly.

Generally, however, when a PHS component is welded with a lower yield strength and/or thinner gauge component, a surface irregularity, such as an indentation, may be created at the weld on the lower strength and/or thinner gauge component. Such a surface irregularity is generally the result of the amount of energy required to melt the PHS being significantly greater than the amount of energy required to melt the material of the component having a lower yield strength. Typically, surface irregularities on finished assemblies are undesirable, and may require post-processing to repair or conceal such a blemish. To remedy the foregoing concern, the system 10 is used to generate the assembly 12 by forming the projections 18 on the component 14, and subsequently joining the panel 12 and the component 14 at the projections.

As noted above, because of press-hardening and quenching, the material of component 14 attains increased yield strength and suffers a decrease in ductility. Consequently, the forming of the projections 18 in the component 14 is limited by the ability of the component's base material to withstand deformation without developing splits and tears. To aid in the formation of projections 18, specific regions 20 on the component 14 from which the projections will be subsequently formed are identified for annealing.

Annealing is a heat treatment applied to a material that is intended to alter the material properties such as strength and hardness. Annealing is typically performed by heating the subject material to above the material's re-crystallization temperature, maintaining the selected temperature for a period of time, and then cooling. Annealing is commonly used to improve the material's ductility, relieve internal stresses, refine the material's structure by making it more homogeneous, and improve the material's cold working properties. Depending on the subject material, following the heating stage, the material may be allowed to cool slowly to ambient conditions, or be cooled more quickly by quenching it in a fluid. Following the annealing process, the material's formability is improved, i.e., the material is typically softened sufficiently for further shaping, forming, or stamping.

The system 10 includes a fixture 22 configured to position and hold the pre-formed and quenched PHS component 14. As shown in FIG. 1, the fixture 22 includes a clamping mechanism 24. The clamping mechanism 24 is configured to hold the PHS component 14 in a fixed position during annealing. As shown in FIG. 1, the system 10 also includes heating elements 26 configured to anneal the regions 20 and increase formability thereof prior to forming of the projections 18. The heating elements 26 are electrical devices that can generate thermal energy for annealing regions 20 in response to an electric current that is sent through the heating elements by an external power supply (not shown). The heating elements 26 may include induction coils which are typically fabricated from copper tubing shaped to complement the shape of the regions 20.

As shown in FIGS. 1-3, the system 10 may also include an end-of-arm tooling 28. The end-of-arm tooling 28 incorporates the heating elements 26 and is configured to translate the heating elements into appropriate position for annealing the regions 20. The end-of-arm tooling 28 may be mounted on an appropriate transfer mechanism such as a gantry robot 29 that is depicted in FIGS. 1-3. The gantry robot 29 is a Cartesian-coordinate industrial robot that is configured to be operated in a straight line rather than rotate along three principal control axes. The transfer mechanism for mounting the end-of-arm tooling 28 may also be configured as a linear transfer mechanism, or a robotic arm (not shown) that are commonly used in transfer stamping lines.

As shown in FIGS. 1-3, the system 10 also includes a device 30 configured to form the projections 18 on the regions 20 after the regions have been annealed. The device 30 may be a stamping press having an upper die 32 and a lower die 34. FIG. 2 specifically shows the device 30 forming the projections 18 on the regions 20. As may be seen in FIGS. 1-3, the fixture 22 may be incorporated into the device 30, such that the component 14 does not need to be repositioned or transferred for forming of the projections 18 following the annealing of regions 20.

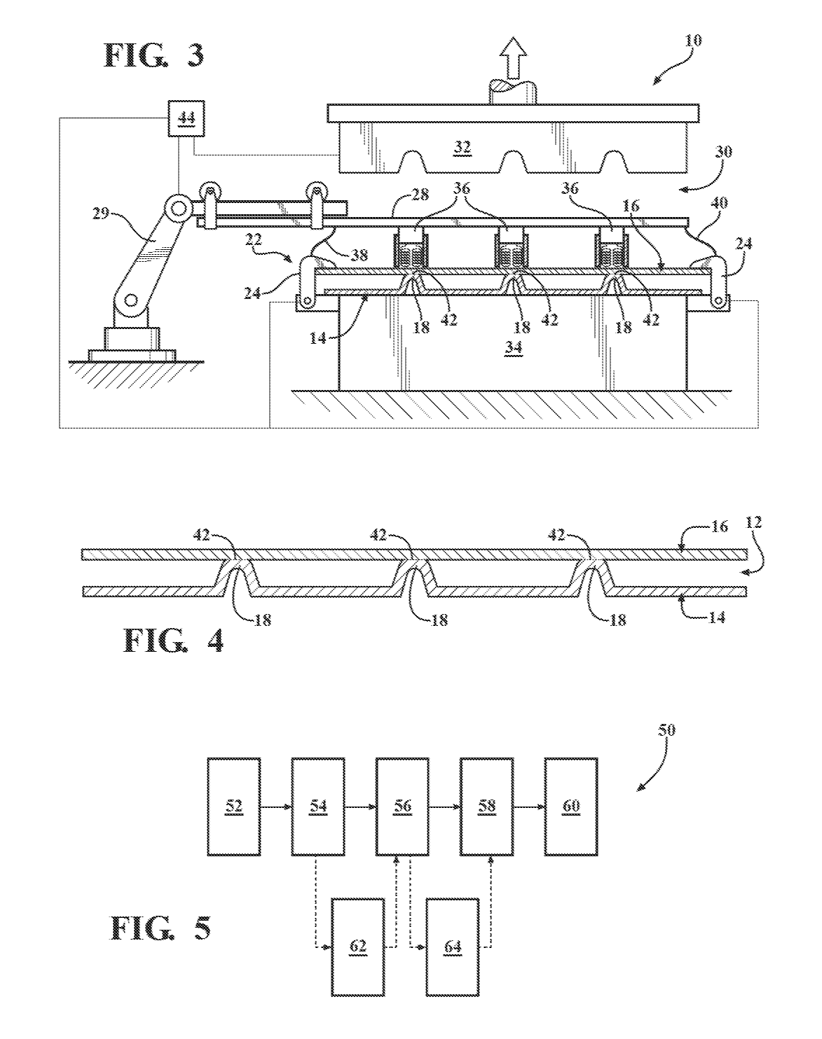

As shown in FIG. 3, the panel 16 may be brought in and placed or stacked against the projections 18 of the component 14 while the component remains in the fixture 22. Alternatively, the component 14 may be transferred to a separate station of the system 10 (not shown) to be joined with the panel 16. After the component 14 and the panel 16 are stacked together, the assembly 12 may be generated by generating welds at the projections 18. The clamping mechanism 24 may be additionally configured to clamp the panel 16 against the projections 18 when the panel and the component are being joined. In such a case, the clamping mechanism 24 is configured to be sufficiently adjustable to hold the component 14 alone, or clamp and hold the panel 16 against the component 14. In the event that the fixture 22 is set up independently from the device 30, an additional and separate clamping mechanism (not shown) configured to clamp the component 14 and panel 16 together may be provided.

As shown in FIG. 3, a welding apparatus 36 configured to join the panel 16 and the component 14 at the projections 18 may be delivered to and positioned relative to the stacked component 14 and panel 16. The welding apparatus 36 may be configured as any appropriate generator of a pool of welded material at the projections 18, for example an electric resistance welding arc, or any of a laser, electron, and plasma beams. When electric resistance welding is used, the welding apparatus 36 includes a pair of electrodes—a first electrode 38 and a second electrode 40. As shown in FIG. 3, the electrodes 38, 40 may be incorporated into the clamping mechanism 24, wherein each electrode is connected to an individual clamp. The electrodes 38, 40 are configured to pass electric current through the clamped component 14 and panel 16 at the projections 18 when the weld is being formed.

When the current is passed through the electrodes 38, 40 to the clamped component 14 and panel 16, thermal energy is generated at spots 42 where projections 18 contact the panel 16, as a result of electrical resistance being highest at the contact spots. The thermal energy generated by the electrical resistance is localized at the projections 18, and results in the metal of each of the clamped component 14 and panel 16 at the spot 42 to melt. When the current is stopped, the welds cool allowing the metal at the spots 42 to solidify, thus completing the welded assembly 12 that is shown in FIG. 4.

As shown in FIGS. 1-3, a controller 44 may be part of the system 10. As shown in FIG. 1, the controller 44 may be connected to and be employed to regulate the operation of the heating elements 26, the device 30, and the welding apparatus 36. Accordingly, the controller 44 may be programmed to initially execute the annealing of the regions 20, then form the projections 18 on the annealed regions, and, subsequently, to weld the component 14 to the panel 16 at the spots 42.

FIG. 5 depicts a method 50 of generating the welded assembly 12 via the system 10, as described above with respect to FIGS. 1-2. Method 50 commences in frame 52 where it includes providing the pre-formed PHS component 14, and then proceeds to frame 54. In frame 54, the method includes annealing the regions 20 on the component 14 via heating elements 26 to impart a local temper to the regions such that formability of those regions is increased. As described with respect to FIG. 1, during the annealing of the regions 20, the component 14 may be held and positioned by the clamping mechanism 24 of the fixture 22.

After frame 54, the method advances to frame 56. In frame 56, the method includes forming the projections 18 on the annealed regions 20. Following the formation of the projection 18, the method proceeds to frame 58. In frame 58, the method includes clamping the panel 16 against the projections 18. After frame 58, the method advances to frame 60 where it includes joining the component 14 and the panel 16 at the projections 18 via the welding apparatus 36 to generate the welded assembly 12 that is depicted in FIG. 4. If the fixture 22 is incorporated into the device 30, as described above, the clamping mechanism 24 may be additionally configured to clamp the panel 16 against the projections 18 when the panel and the component are being joined.

In the event that the fixture 22 is not incorporated into the device 30, instead of proceeding from frame 54 directly to frame 56, the method would proceed from frame 54 to frame 62, and then to frame 56. In frame 62, the method would include transferring the component 14 to the device 30 for forming of the projections 18, which occurs in frame 56. Similarly, after the projections 18 have been formed in frame 56, if the welding apparatus 36 cannot be brought into the device 30, instead of proceeding from frame 56 directly to frame 58, the method would advance from frame 56 to frame 64, and then to frame 58. In frame 64, the method would include transferring the component 14 and the panel 16 to the welding apparatus 36 for clamping the panel 16 against the projections 18, which subsequently occurs in frame 58.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of generating a welded assembly, the method comprising:
annealing a region on a work-hardened steel component to impart a local temper to the region such that formability of the region is increased;
forming a projection on the annealed region;
clamping a panel against the projection; and
joining the panel and the work-hardened steel component at the projection via a welding apparatus to generate the welded assembly.

2. The method of claim 1, wherein the work-hardened steel component is formed from a high-strength low-alloy steel and the panel is formed from mild-steel.

3. The method of claim 1, wherein the work-hardened steel component is a press-hardened structural reinforcement for the panel.

4. The method of claim 1, wherein said joining the panel and the work-hardened steel component is accomplished via electric resistance welding.

5. The method of claim 1, wherein said annealing of the region on the work-hardened steel component is accomplished via a heating element.

6. The method of claim 5, wherein the heating element includes an induction coil.

7. The method of claim 1, wherein the welding apparatus includes a pair of electrodes, and wherein said clamping the panel against the projection is accomplished via the pair of electrodes.

8. A system for generating a welded assembly, the system comprising:
a fixture configured to hold the work-hardened steel component;
a heating element configured to anneal a region on the work-hardened steel component;
a device configured to form a projection on the annealed region;
a clamping mechanism configured to clamp a panel against the projection; and
a welding apparatus configured to join the panel and the work-hardened steel component at the projection;
wherein the heating element anneals the region on the work-hardened steel component to increase formability of the region prior to forming the projection.

9. The system of claim 8, wherein the work-hardened steel component is formed from a high-strength low-alloy steel and the panel is formed from mild-steel.

10. The system of claim 8, wherein the work-hardened steel component is a press-hardened structural reinforcement for the panel.

11. The system of claim 8, wherein the welding apparatus is configured to join the panel and work-hardened steel component via electric resistance welding.

12. The system of claim 8, wherein the heating element includes an induction coil.

13. The system of claim 8, wherein the clamping device includes a pair of electrodes that are operatively connected to the welding apparatus.

14. A method of generating a reinforced assembly, the method comprising:
annealing via a heating element a plurality of regions on a press-hardened steel reinforcement such that formability of the plurality of regions is increased;
forming a plurality of projections such that each of the plurality of projections is formed on one of the annealed plurality of regions;
clamping a mild-steel panel against the plurality of projections; and
joining the press-hardened steel reinforcement and the mild-steel panel at the plurality of projections via a welding apparatus to generate the reinforced assembly.

15. The method of claim 14, wherein the press-hardened steel component is formed from a high-strength low-alloy steel.

16. The method of claim 14, wherein said joining the mild-steel panel and the work-hardened steel reinforcement is accomplished via electric resistance welding.

17. The method of claim 14, wherein the heating element includes an induction coil.

18. The method of claim 14, wherein the welding apparatus includes a pair of electrodes, and wherein said clamping the panel against the plurality of projections is accomplished via the pair of electrodes.

19. A method of generating a welded assembly, the method comprising:
annealing a region on a work-hardened steel component formed from a high-strength low-alloy steel to impart a local temper to the region such that formability of the region is increased;
forming a projection on the annealed region;
clamping a panel formed from mild-steel against the projection; and
joining the panel and the work-hardened steel component at the projection via a welding apparatus to generate the welded assembly.

20. The method of claim 19, wherein the welding apparatus includes a pair of electrodes, wherein the forming is accomplished between an upper die and a lower die, wherein the pair of electrodes is arranged on the lower die, and wherein said clamping the panel against the projection is accomplished via the pair of electrodes.
